(19) United States
(12) Patent Application Publication
(10) Pub. No.: US 2013/0241406 A1
(43) Pub. Date: Sep. 19, 2013

(54) METHOD AND SYSTEM FOR REMOTELY CONTROLLING AN LED BULB

(71) Applicant: Haguite Houri, Hollywood, FL (US)

(72) Inventor: Haguite Houri, Hollywood, FL (US)

(21) Appl. No.: 13/421,852

(22) Filed: Mar. 15, 2012

(51) Int. Cl. H05B 37/02

(52) U.S. Cl. 315/34

(57) ABSTRACT

Disclosed is a light-emitting diode bulb assembly comprising: a light-emitting diode board, the light-emitting diode board having disposed thereon at least one light-emitting diode; a driver module in electrical communication with the light-emitting diode board, the driver module including a driver for each light-emitting diode disposed on the light-emitting diode board; a microcontroller board in electrical communication with the driver module, the microcontroller board including a memory having a unique individual stored serial number identifier for the light emitting diode bulb assembly; and an RF module in electrical communication with the microcontroller board, the RF module including an RF antenna for receiving operating signals either directly from a remote wireless control device or indirectly via a gateway.

### FIELD OF THE INVENTION

The present invention relates to controlling light and, more particularly, to a system and method for providing control to a lighting environment illuminated by a plurality of light emitting diode bulb assemblies.

### BACKGROUND OF THE INVENTION

Conventional lighting systems are known in the prior art, but most such systems control only the brightness, or intensity level, of a lighting installation. With the advent of light emitting diode, a more efficient and longer-lasting source of illumination was available, but the new technology lacked the means to remotely control the brightness and color of LED lighting bulbs.

What is needed is a method for controlling the color of ambiance LED lighting.

### BRIEF SUMMARY OF THE INVENTION

In one aspect of the present invention, a light-emitting diode bulb assembly comprises: a light-emitting diode board, the light-emitting diode board having disposed thereon at least one light-emitting diode; a driver module in electrical communication with the light-emitting diode board, the driver module including a driver for each light-emitting diode disposed on the light-emitting diode board; a microcontroller board in electrical communication with the driver module, the microcontroller board including a memory having a unique individual stored serial number identifier for the light emitting diode bulb assembly; and an RF module in electrical communication with the microcontroller board, the RF module including an RF antenna for receiving operating signals either directly from a remote wireless control device or indirectly via a gateway.

In another aspect of the present invention, a method of controlling a light-emitting diode bulb assembly comprises: assigning a serial number to the light-emitting diode bulb assembly; and remotely communicating with the light-emitting diode bulb assembly using a wireless signal encoded with the serial number.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is an exploded diagrammatical illustration of interior components of an LED bulb assembly, in accordance with the present invention;

FIG. 2 is a diagrammatical view of communication devices functioning to control components of an LED bulb assembly; and

FIG. 3 is a diagrammatical illustration of a handheld communication device remotely controlling operation of a plurality of LED bulb assemblies.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The present invention relates generally to a system and method for providing remotely controllable, artificial lighting for living and working environments

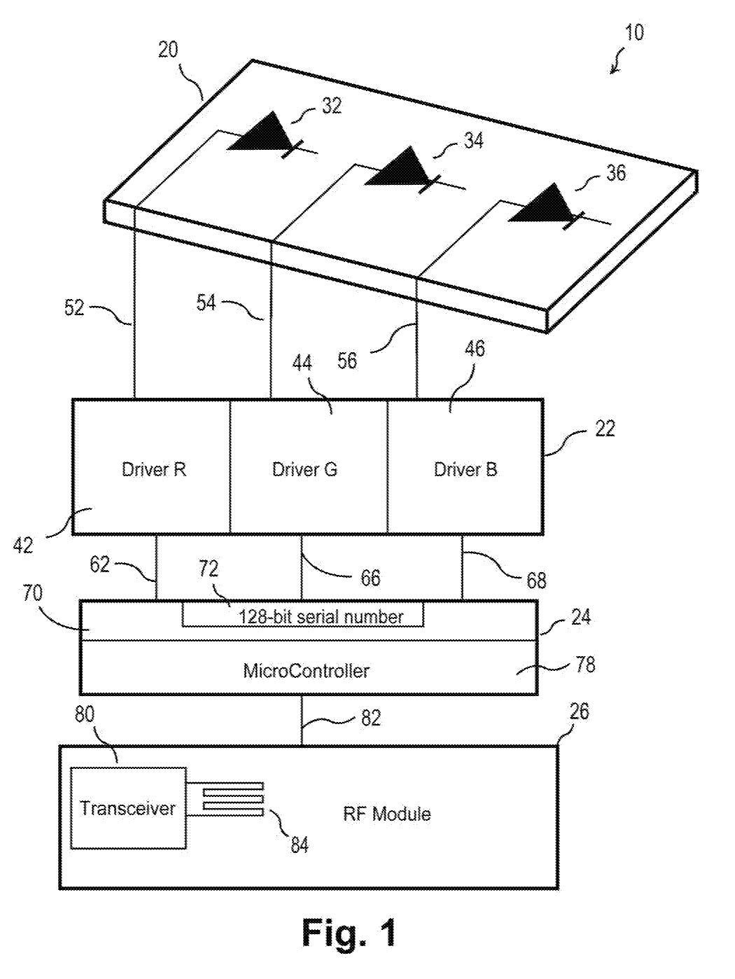

There is shown in FIG. 1 a diagrammatical illustration of a remotely controllable light emitting diode (LED) bulb assembly 10, in accordance with the present invention. Although the LED bulb assembly 10 is typically housed in an enclosure, the enclosure is not shown, for clarity of illustration. The LED bulb assembly 10 comprises an LED board 20, a driver assembly 22, a microcontroller board 24, and an RF module 26. The LED board 20 includes a plurality of LEDs, wherein two or more of the LEDs may operate in the same color or in different colors, in accordance with design specifications. In the example provided, the LED board includes a red LED 32, a green LED 34, and a blue LED 36.

In an exemplary embodiment, a first LED driver 42 (here denoted as ‘Driver R’) may be used to provide an electrical current to power and control the red LED 32 via a first electrical conductor 52. Similarly, a second LED driver 44 (here denoted as ‘Driver G’) may be used to provide an electrical current to power and control the green LED 34 via a second electrical conductor 54, and a third LED driver 46 (here denoted as ‘Driver B’) may be used to provide an electrical current to power and control the blue LED 36 via a third electrical conductor 56. It should be understood that the electrical conductors 52, 54, 56 may comprise insulated copper conductors, or conductive traces on a circuit board.

It can be appreciated by one skilled in the art that a substantially white light can be produced by controlling the relative output intensities of the red LED 32, the green LED 34, and the blue LED 36 by means of the first LED driver 42, the second LED driver 44, and the third LED driver 46. Alternatively, the aggregate light output of the LED board 20 may be varied from white to another spectral color that may be produced by appropriately adjusting the relative radiation outputs of the individual LEDs 32, 34, and 36. It should be further understood that the LED board may comprise a greater number of LEDs, selected so as to allow a user to “dial in” a particular aggregate color output, ranging from the primary and secondary colors, to substantially white light of different Kelvin temperatures (e.g., from a “yellowish” light at 3500° K to a “pure” white light at 5000° K).

The drivers 42, 44, and 46 may be controlled by the microcontroller board 24. The LED bulb assembly 10 may be assigned a unique individual 128-bit serial number 72 stored in a non-volatile MCU memory 70 on the microcontroller board 24, Electrical current levels provided to the LEDs 32, 34, and 36 may be controlled by a microcontroller 78 on the microcontroller board 24 and the first LED driver 42 (Driver R), the second LED driver 44 (Driver G), and the third LED driver 46 (Driver B).

These individual, unique, and different 128-bit serial numbers may be used as identifiers to one or more wireless communication device, as explained in greater detail below. In an exemplary embodiment, the microcontroller board 24 may operate in accordance with a Digital Addressable Lighting Interface (DALI) lighting system interface, such as specified in IEC Standard 60929, or in accordance with any other wireless communications protocol, as known in the art. Accordingly, the microcontroller board 24 may communicate one or more commands to one or more of the LEDs 32, 34, 36 on the LED board 20 so as to provide a complete wireless, remote control of the LED bulb assembly 10.

This configuration enables a remote wireless user to have complete automation of one or more LED bulb assemblies 10, with functions and features including: (i) a dimmer; (ii) a timing dimmer; (iii) a custom “light scene;” (iv) one or more blinking LEDs, (v) aggregate color change of the emission from the LED board 20; (vi) a security mode, (vii) an “alert” mode; and (viii) a “savings” mode where “on” and “off” times are controlled to minimize electricity usage. The LED bulb assembly 10 may further include means for tracking and calculating energy consumption by one or more LEDs, for example, and may include means for recording cumulative operating time, or for recording periods of energy consumption for LEDs that may be operated on an intermittent basis.

Wireless remote control of the LED bulb assembly 10 may be provided by a transceiver 80 and antenna 84 integrated into the RF module 26. The RF module 26 may communicate with the microcontroller board 24 by sending control signals via a connecting cable 82. In an exemplary embodiment, remote communication with the RF module 26 may be enabled in accordance with communication signals operating in the 2.4 GHz frequency range, such as specified by the ZigBee high-level communication protocols based on the IEEE 802 standard for personal area networks.

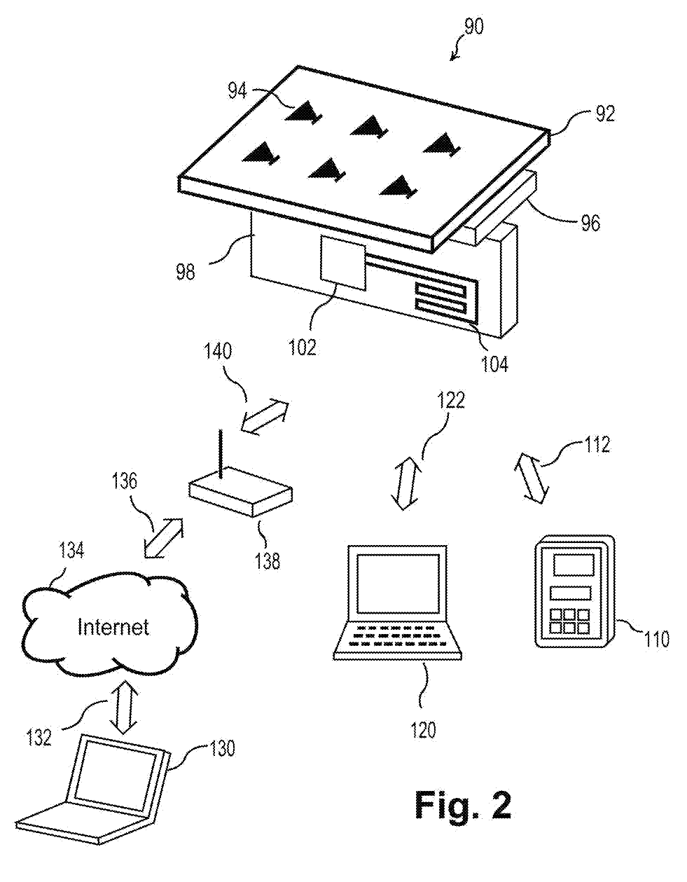

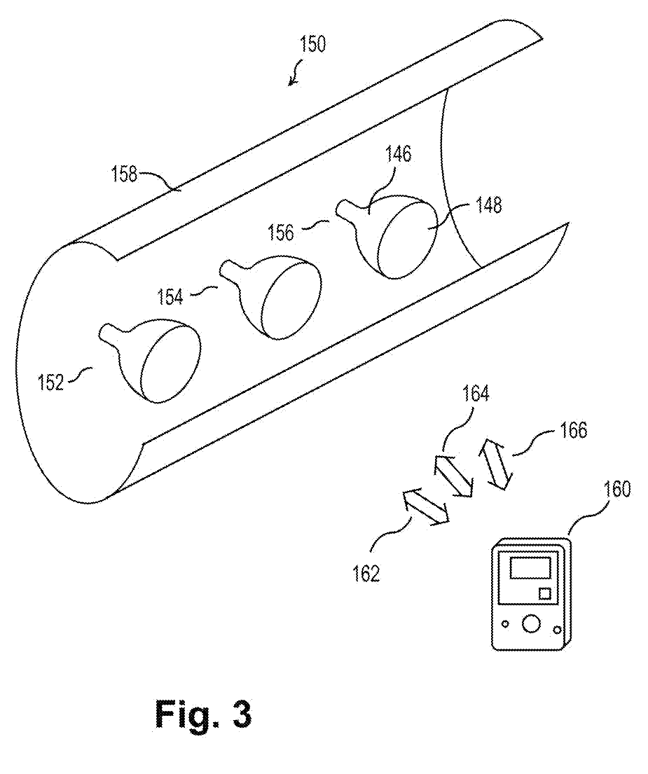

In an exemplary embodiment, an LED bulb assembly 90 may be remotely and wirelessly controlled by any of a number of communication devices, such as a SMARTPHONE 110 or a local laptop computer 120, shown in FIG. 2. In the configuration shown, the LED bulb assembly 90 comprises an LED board 92, a combined driver and microcontroller board 96, and an RF board 98. The LED board 92 may include a plurality of LEDs 94 of different or similar light outputs, and may include more or fewer than the six LEDs 94 shown in the illustration. The LED bulb assembly 90 may also be housed in an enclosure with an optic face (such as shown in FIG. 3) to maintain the integrity of the boards 92, 96, 98.

The SMARTPHONE 110 may communicate directly with the LED bulb assembly 90 via an RF transceiver 102 and an RF antenna 104 fabricated on the RF board 98. A communication link 112 between the SMARTPHONE 110 and the RF transceiver 102 may function in accordance with the DALI standard, as noted above. In an exemplary embodiment, the laptop computer 120 may likewise communicate with the LED bulb assembly 90 via the RF antenna 104, in accordance with the wireless DALI protocol.

The LED bulb assembly 90 may also be operated from a remote location, as shown in the illustration. A remote computer 130 may access a network, such as the Internet 134, via a Wi-Fi connection 132. There is provided a gateway 138 within the range of the LED bulb assembly 90 that may be used to receive communication indirectly from the remote computer 130 via a local Wi-Fi link 136. The remote computer 130 may communicate directly with the gateway 138, and may thus communicate indirectly with the LED bulb assembly 90 via a DALI link 140 established between the gateway 138 and the RF antenna 104.

FIG. 3 shows a personal wireless communication device 160 being used to control a set of LED bulbs 152, 154, 156 mounted in a fixture 158. In the example provided, each LED bulb 152, 154, 156 includes a housing or enclosure 146, where an optic element 148 is provided in the enclosure 146 to modify the output light beam as specified by a designer of the LED bulbs 152, 154, 156.

As explained above, each LED bulb 152, 154, 156 includes a respective unique 128-bit serial number or identifier. Accordingly, the first LED bulb 152 may respond only to a first wireless signal 162 transmitted by the personal wireless communication device 160. Similarly, the second LED bulb 154 may respond only to a second wireless signal 164, and the third LED bulb 156 may respond only to a third wireless signal 166. It should be understood that the individual wireless signals 162, 164, 166 are shown for convenience of illustration only, and that the personal wireless communication device 160 may function by sending out a single encoded signal to which only one or a select few LED bulbs will respond.

With this configuration, the personal wireless communication device 160 controls not only the relative intensity of illumination being emitted by each of the LED bulbs 152, 154, 156, but may also control the dimming and “blinking” of each of the LED bulbs 152, 154, 156. In an exemplary embodiment, the LED bulbs 152, 154, 156 may send operating data (e.g., power consumption, bad LED, operating efficiency) back to a control device, such as the personal wireless communication device 160.

It is to be understood that the description herein is exemplary of the invention only and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

What is claimed is:

1. A light-emitting diode bulb assembly suitable for being remotely controlled by a wireless communication device, said light-emitting diode bulb assembly comprising:
a light-emitting diode board, said light-emitting diode board having disposed thereon at least one light-emitting diode;
a driver module in electrical communication with said light-emitting diode board, said driver module including a driver for each said light-emitting diode disposed on said light-emitting diode board;
a microcontroller board in electrical communication with said driver module, said microcontroller board including a memory having a unique individual stored serial number identifier for said light emitting diode bulb assembly; and
an RF module in electrical communication with said microcontroller board, said RF module including an RF antenna for receiving operating signals either directly from the remote wireless communication device or indirectly via a gateway.

2. The light-emitting diode bulb assembly of claim 1 wherein said light-emitting diode board comprises at least a first light-emitting diode of a first color and a second light-emitting diode of a second color.

3. The light-emitting diode bulb assembly of claim 1 wherein said light-emitting diode bulb assembly responds to the wireless communication device when said unique individual stored serial number identifier is transmitted to said light emitting diode bulb assembly.

4. The light-emitting diode bulb assembly of claim 3 wherein said unique individual stored serial number identifier is transmitted to said light emitting diode bulb assembly in accordance with at least one of a Digital Addressable Lighting Interface protocol or a wireless communications protocol.

5. The light-emitting diode bulb assembly of claim 3 wherein said driver module comprises an LED driver for each of said light-emitting diodes.

6. The light-emitting diode bulb assembly of claim 3 wherein said driver module and said microcontroller board comprise a single unitary module.

7. The light-emitting diode bulb assembly of claim 3 further comprising an enclosure with an optic element for to modifying an output light beam, at least one of said driver module, said microcontroller board, and said RF module disposed within said enclosure.

8. A method of controlling a light-emitting diode bulb assembly, said method comprising the steps of:
assigning a serial number to said light-emitting diode bulb assembly; and
remotely communicating with said light-emitting diode bulb assembly using a wireless signal encoded with said serial number.

9. The method of claim 8 wherein said step of remotely communicating comprises the step of transmitting a control signal from an RF transceiver in said light-emitting diode bulb assembly to a driver module board in said light-emitting diode bulb assembly.

10. The method of claim 8 wherein said step of remotely communicating comprises the step of establishing communication between said light-emitting diode bulb assembly and at least one of a remote wireless communication device or a gateway, said step of remotely communicating performed in accordance with at least one of a Digital Addressable Lighting Interface protocol or a wireless communications protocol.

11. The method of claim 10 further comprising the step of sending operating data from said light-emitting diode bulb assembly to said wireless communication device.

12. The method of claim 11 wherein said operating data comprises at least one of power consumption data, bad LED data, and operating efficiency data.

13. A system for remotely controlling a lighting source, said system comprising:
at least one light-emitting diode bulb, said at least one light-emitting diode having
a light-emitting diode board with at least one light-emitting diode;
a driver module in electrical communication with said light-emitting diode board;
a microcontroller board in electrical communication with said driver module, said microcontroller board including a memory having a unique individual stored serial number identifier for said light emitting diode bulb assembly;
an RF module in electrical communication with said microcontroller board, and
at least one of a remote communication device in wireless communication with said at least one light-emitting diode bulb or a gateway in wireless communication with said at least one light-emitting diode bulb.

14. The system of claim 13 wherein said light-emitting diode bulb assembly responds to said remote communication device when said unique individual stored serial number identifier is wirelessly transmitted to said light emitting diode bulb assembly by said remote communication device.

15. The system of claim 14 wherein said unique individual stored serial number identifier is transmitted to said light emitting diode bulb assembly in accordance with at least one of a Digital Addressable Lighting Interface protocol or a wireless communications protocol.

16. The system of claim 15 wherein said RF module functions to send said transmitted unique individual serial number to said driver module.

17. The system of claim 13 wherein said light-emitting diode bulb assembly responds to said gateway wireless communication when said unique individual stored serial number identifier is transmitted to said light emitting diode bulb assembly by said gateway.

18. The system of claim 13 wherein said light- emitting diode bulb assembly comprises a first light-emitting diode of a first color and a second light-emitting diode of a second color.
